(19) United States
(12) Patent Application Publication
(10) Pub. No.: US 2026/0133968 A1
(43) Pub. Date: May 14, 2026

(54) Adaptive Answer-Generating Agent

(71) Applicant: Sage Global Services Limited, Newcastle Upon Tyne (GB)

(72) Inventors: Brett Powley, New South Wales (AU); David Loving, Oklahoma City, OK (US); Liudmyla Nechepurenko, Melbourne (AU)

(21) Appl. No.: 18/946,002

(22) Filed: Nov. 13, 2024

(51) Int. Cl. G06F 16/2453; G06F 16/21; G06F 16/242

(52) U.S. Cl. CPC G06F 16/24539; G06F 16/212; G06F 16/213; G06F 16/243

(57) ABSTRACT

An adaptive answer-generating agent implemented on a computer system, communicatively connected to a user device, and configured to: receive a user query from the user device; map the user query to one of a plurality of reconfigurable answer-generation schemas stored in first data storage, each of the answer-generation schema specify a sequence of steps to generate an answer output to the query, said agent including an answer generation engine configured to: receive the answer-generation schema mapped to the user query; implement the sequence of steps to generate an answer output, and communicate the answer output to the user device, wherein the agent further includes a schema modification function configured to: receive schema modification data from a further computing device relating to one or more of the answer-generation schemas, and modify the sequence of steps of the one or more of the answer-generation schemas in accordance with the schema modification data.

### TECHNICAL FIELD

The present invention relates to techniques for implementing answer-generating agents.

### BACKGROUND

Recent advances in generative AI have led to efforts to develop query-answering “agents” that are capable of providing answers to user queries.

There is particular interest in developing specialised agents for specific domains, where the agents can use domain-specific knowledge and resources to provide more accurate and relevant answers to user queries.

One such domain is finance and accounting, where the automation of certain tasks by suitably configured query-answering agents can substantially enhance workflow efficiencies. Such tasks include typically time-consuming activities, for example those which involve looking up financial data and calculating metrics, such as financial ratios, cash flows, or profitability analysis.

The conventional approach to implementing domain-specific agents is using a specially engineered set of prompts that are tested and known to work well in that domain. These prompts are passed to a general large language model (LLM) and/or an LLM that is fine-tuned to operate in the domain in question. In some examples, agent architectures first convert a user query into a plan and then execute the plan, which allows for information retrieval and information processing, such as performing calculations.

However, once configured and deployed, improving the performance of such agent architectures (for example, because it emerges that the agent performs poorly at answering queries of a particular type or because of changes in the domain itself) involves either prompt engineering (which often involves writing ever longer, more constrained prompts) and/or retraining the model using additional domain-specific data.

Prompt engineering is inexact, and as prompts lengthen, improvements in performance can become increasingly inconsistent, requiring yet further prompt engineering. Moreover, it can be difficult or impossible to modify a prompt to improve performance on one query without adversely affecting its performance on other queries. Retraining the model is expensive and time consuming, and typically requires additional data and substantial time and computing resources.

Updating an agent to respond to new types of queries can be difficult for the same reasons.

Another significant drawback of current techniques for implementing query-answering agents is their high sensitivity to the specific formulation of input queries in natural language, which is inherently ambiguous and variable. Different users may phrase the same underlying query in various ways, employing different words, syntax, or punctuation. These variations can lead to substantially different outputs from the model, resulting in inconsistent or inaccurate responses, even when the semantic intent remains the same. This issue is exacerbated when agents rely on pre-engineered prompts tailored to specific input formats, making them less adaptable to diverse query expressions. Moreover, many LLMs introduce randomness or diversity in their outputs, further increasing variability. While such features may benefit certain generative tasks, they are problematic for answering agents that require precision and reliability. Consequently, there is a need for techniques that reduce dependence on the specific wording of queries and promote more deterministic behaviour, ensuring consistent and accurate responses regardless of how a query is phrased.

### SUMMARY OF THE INVENTION

In accordance with a first aspect of the invention, there is provided a computer implemented adaptive answer-generating agent, said adaptive answer-generating agent implemented on a computer system and communicatively connected to a user device, said adaptive answer-generating agent configured to: receive a user query from the user device; map the user query to one of a plurality of reconfigurable answer-generation schemas stored in first data storage, each of the answer-generation schema specify a sequence of steps to generate an answer output to the query, said adaptive answer-generating agent comprising an answer generation engine configured to: receive the answer-generation schema mapped to the user query; implement the sequence of steps to generate an answer output, and communicate the answer output to the user device, wherein the adaptive answer-generating agent further comprises a schema modification function configured to: receive schema modification data from a further computing device relating to one or more of the answer-generation schemas, and modify the sequence of steps of the one or more of the answer-generation schemas in accordance with the schema modification data.

Optionally, at least some of the reconfigurable answer-generation schemas specify a sequence of steps to generate a prompt to pass to an AI model to answer a query, and when such a reconfigurable answer-generation schema is mapped to a user query, the answer generation engine is configured to: generate a prompt in accordance with the sequence of steps of the answer-generation schema mapped to the user query, and pass the prompt to an AI model to generate the answer output.

Optionally, on receipt of schema modification data relating to a reconfigurable answer-generation schema specifying a sequence of steps to generate a prompt, the schema modification function is configured to: modify the sequence of steps to generate the prompt for the AI model.

Optionally, the reconfigurable answer-generation schemas that specify a sequence of steps to generate a prompt to pass to an AI model to answer a query, comprise steps to: obtain one or more prompt variables in accordance with prompt-variable obtaining instructions, insert the one or more obtained prompt variables into a prompt template to generate the prompt, and the schema modification data relating to a reconfigurable answer-generation schema specifying a sequence of steps to generate a prompt, comprises modification data to modify the sequence of steps by modifying one or more of the prompt template, prompt-variable obtaining instructions and prompt variables.

Optionally, the prompt-variable obtaining instructions comprise data retrieval instructions specifying how to retrieve data for determining one or more prompt variables from one or more data sources.

Optionally, the one or more data sources comprises one or more of: one or more specified databases; one or more specified APIs; a retrieval augmented generation (RAG) system, and one or more data processing functions.

Optionally, one or more of the reconfigurable answer-generation schemas specify a sequence of steps comprising at least one step that includes instructions for a dynamic generation of a sequence of one or more sub-steps, which are executed by the answer generation engine to generate the prompt.

Optionally, the instructions for the dynamic generation of the sub-steps specify use of an AI model to generate the sub-steps based on parameters obtained from the user query.

Optionally, the adaptive answer-generating agent further comprises an embedding module and a schema selection manager, wherein the data storage has stored thereon a plurality of example query embeddings, each of which are embeddings of an example user query, said plurality example query embeddings organised into a plurality of query embedding sets, each query embedding set indexed to one of the reconfigurable answer-generation schemas, wherein said embedding module is configured to generate an embedding of the received user query and said schema selection manager configured to: match the user query embedding to one of the plurality of example query embeddings; identify a query embedding set to which the example query embedding is allocated; identify the answer-generation schema to which the identified query embedding set is indexed, and map the user query to the identified answer-generation schema.

Optionally, prior to generating the prompt in accordance with the answer-generation schema, the answer generation engine is configured to: query further data storage for a cached answer stored in a memory for the user query; and if there is a cached answer outputting the cached answer as the answer output to the user query without generating the prompt.

Optionally, at least some of the reconfigurable answer-generation schemas specify answer data retrieval instructions for retrieving an answer output via a direct look-up from a data source, and when such a reconfigurable answer-generation schema is mapped to a user query, the answer generation engine is configured to: retrieve the answer output from the data source in accordance with the data retrieval instructions.

Optionally, the schema modification function is further configured to: receive schema creation data from the further computing device specifying a new answer-generation schema, and add a new reconfigurable answer-generation schemas to the plurality of reconfigurable answer-generation schemas in accordance with the schema creation data.

In accordance with a second aspect of the invention there is provided a computer-implemented method for updating an adaptive answer-generating agent implemented on a computer system, said adaptive answer-generating agent configured to: receive a user query from the user device; map the user query to one of a plurality of reconfigurable answer-generation schemas stored in first data storage, each of the answer-generation schema specify a sequence of steps to generate an answer output to the query, said adaptive answer-generating agent comprising an answer generation engine configured to: receive the answer-generation schema mapped to the user query; implement the sequence of steps to generate an answer output, and communicate the answer output to the user device, said method comprising: receiving, at the adaptive answer-generating agent, schema modification data from a further computing device relating to one or more of the answer-generation schemas, and modifying the sequence of steps of the one or more of the answer-generation schemas in accordance with the schema modification data.

Optionally, at least some of the reconfigurable answer-generation schemas specify a sequence of steps to generate a prompt to pass to an AI model to answer a query, and when such a reconfigurable answer-generation schema is mapped to a user query, the answer generation engine is configured to: generate a prompt in accordance with the sequence of steps of the answer-generation schema mapped to the user query, and pass the prompt to an AI model to generate the answer output.

Optionally, on receipt of schema modification data relating to a reconfigurable answer-generation schema specifying a sequence of steps to generate a prompt, the method further comprises: modifying the sequence of steps to generate the prompt for the AI model.

Optionally, the reconfigurable answer-generation schemas that specify a sequence of steps to generate a prompt to pass to an AI model to answer a query, comprise steps to: obtain one or more prompt variables in accordance with prompt-variable obtaining instructions, insert the one or more obtained prompt variables into a prompt template to generate the prompt, and the schema modification data relating to a reconfigurable answer-generation schema specifying a sequence of steps to generate a prompt, comprises modification data to modify the sequence of steps by modifying one or more of the prompt template, prompt-variable obtaining instructions and prompt variables.

Optionally, the prompt-variable obtaining instructions comprise data retrieval instructions specifying how to retrieve data for determining one or more prompt variables from one or more data sources.

Optionally, the one or more data sources comprises one or more of: one or more specified databases; one or more specified APIs; a retrieval augmented generation (RAG) system, and one or more data processing functions.

Optionally, one or more of the reconfigurable answer-generation schemas specify a sequence of steps comprising at least one step that includes instructions for a dynamic generation of a sequence of one or more sub-steps, which are executed by the answer generation engine to generate the prompt.

Optionally, the instructions for the dynamic generation of the sub-steps specify use of an AI model to generate the sub-steps based on parameters obtained from the user query.

Optionally, the adaptive answer generating agent comprises an embedding module and a schema selection manager, wherein the data storage has stored thereon a plurality of example query embeddings, each of which are embeddings of an example user query, said plurality example query embeddings organised into a plurality of query embedding sets, each query embedding set indexed to one of the reconfigurable answer-generation schemas, wherein said embedding module is configured to generate an embedding of the received user query and said schema selection manager configured to: match the user query embedding to one of the plurality of example query embeddings; identify a query embedding set to which the example query embedding is allocated; identify the answer-generation schema to which the identified query embedding set is indexed, and map the user query to the identified answer-generation schema.

Optionally, prior to generating the prompt in accordance with the answer-generation schema, the answer generation engine is configured to: query further data storage for a cached answer stored in a memory for the user query; and if there is a cached answer: outputting the cached answer as the answer output to the user query without generating the prompt.

Optionally, at least some of the reconfigurable answer-generation schemas specify answer data retrieval instructions for retrieving an answer output via a direct look-up from a data source, and when such a reconfigurable answer-generation schema is mapped to a user query, the answer generation engine is configured to: retrieve the answer output from the data source in accordance with the data retrieval instructions.

Optionally, the method further comprises: receiving schema creation data from a further computing device specifying a new answer-generation schema, and adding a new reconfigurable answer-generation schemas to the plurality of reconfigurable answer-generation schemas in accordance with the schema creation data.

In accordance with embodiments of the invention a technique is provided for implementing an adaptive user query answering agent. When a user query is received, it is mapped to one of a set of predetermined answer-generation schemas. These schemas specify a sequence of steps to answer the user query. The user query is then answered by implementing the sequence of steps. Advantageously, these sequence of steps are reconfigurable so that they can be readily modified to improve the performance of the answer-generating agent.

Accordingly, to improve or adapt the performance of the answering agent, there is no need to modify the LLM prompt so that it will perform as required on a diversity of user queries (prompt engineering) or retrain or reconfigure any functionality used to generate the answer to the user query (for example model retraining). Moreover, in certain examples, if it is difficult to adapt or update an existing answer-generation schema to answer a particular type of user query (for example, because to do so may degrade the performance in answering other types of queries), a new answer-generation schema can be easily added and a mapping added to the relevant types of user queries.

A further advantage of the invention is that, because all received user queries are mapped to one of a predetermined set of answer-generation schemas, answers are generated in a more deterministic way.

This is because similar queries will typically map to the same answer-generation schema and thus the same sequence of steps will be used to generate the output answer for queries that relate to the same underlying question, even if they are expressed differently. This would not necessarily be the case if differently worded queries were input to a conventional language model, because variation in the format of the input query could result in different outputs, particularly if the language model first made a plan to answer the user query, then executed the plan. By using predefined answer-generation schemas, embodiments of the technique reduce the uncertainty and variability of the answer outputs and ensures consistency and reliability in answering user queries.

Various aspects and features of the invention are defined in the claims.

### BRIEF DESCRIPTION OF THE DRAWINGS

Embodiments of the present invention will now be described by way of example only with reference to the accompanying drawings where like parts are provided with corresponding reference numerals and in which:

FIG. 1 provides a simplified schematic diagram of a computer system for implementing an adaptive answer-generating agent for generating answers to user queries;

FIG. 2 depicts steps of a process for generating an answer to a user query using the system shown in FIG. 1;

FIG. 3 depicts an example of an answer-generation schema in accordance with an illustrative example;

FIG. 4 depicts an example of a modified answer-generation schema in accordance with an illustrative example, and

FIG. 5 provides a simplified schematic diagram of a system for implementing an example adaptive answer-generating agent system in accordance with an example of the invention.

### DETAILED DESCRIPTION

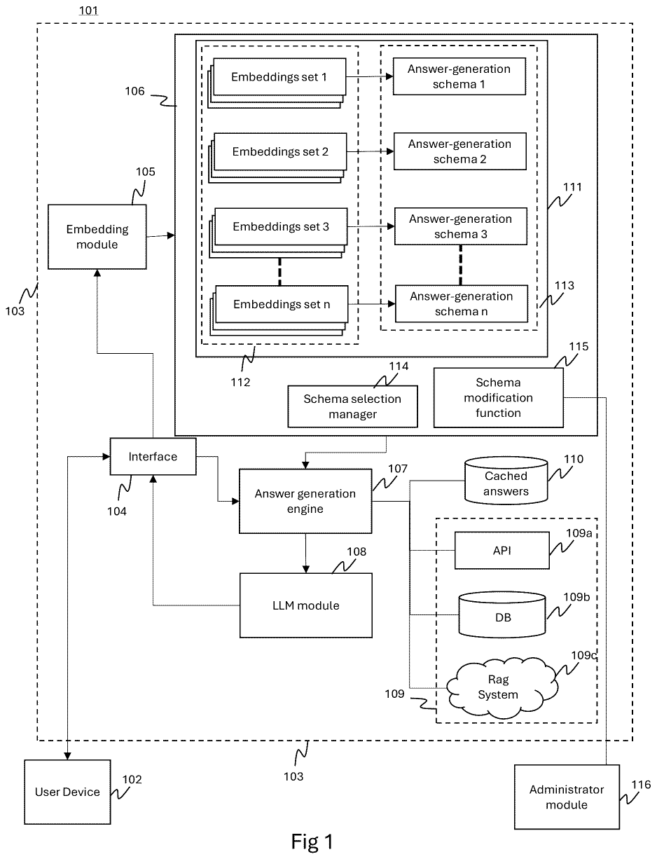

FIG. 1 provides a simplified schematic diagram of a computer system 101 for implementing an adaptive answer-generating agent for generating answers to user queries in accordance with certain examples of the invention.

The computer system 101 comprises a user device 102 communicatively connected to an adaptive answer-generating agent system 103. For clarity, FIG. 1 shows only one user device 102 connected to the adaptive answer-generating agent system 103. However, in practical applications, the adaptive answer-generating agent system 103 is typically capable of being connected to and receiving queries from multiple user devices.

The adaptive answer-generating agent system 103 comprises an interface 104 via which data is communicated to, and received from, the user device 102. In particular, as explained in more detail below, the interface 104 is configured to receive a user query from the user device 102, and communicate an answer output generated by the adaptive answer-generating agent system 103 back to the user device 102.

The interface 104 can be provided by any suitable type of interface, for example a chatbot type interface configured to receive natural language queries from users and present output data in a similar format. As will be understood, such a chatbot type interface is typically provided by a suitably adapted interactive software application that uses natural language processing and artificial intelligence to simulate a human-like conversation with a user. The interface 104 can communicate data to and from the user device 102 in any suitable format, such as text, voice, images, or a combination of these.

The interface 104 can be implemented as a web interface that can be accessed by the user device 102 via a web browser or a similar application running on the user device 102. In such examples, the data exchanged between the user device 102 and the interface 104 is web data, such as HTML, XML, JSON, or any other suitable format. The web interface can allow the user to enter natural language queries in a text box or by voice input or by any other suitable form of input, and display the output data generated by the adaptive answer-generating agent system 103 in a suitable manner. The web interface can also provide additional features, such as buttons, menus, links, or graphics, to enhance the user experience and facilitate the interaction with the interface 104.

The adaptive answer-generating agent system 103 comprises an embedding module 105 connected to the interface 104 which is configured to generate embeddings of user queries received from the user device 102.

The embedding module 105 is connected to a schema selection engine 106 which in turn is connected to an answer generation engine 107. The answer generation engine 107 is connected to an LLM module 108 which is connected to the interface 104. The embedding module 105 can be implemented in any suitable way. For example, it may use a pre-trained neural network model, such as a transformer, an RNN, a CNN, or a hybrid model, which is fine-tuned on domain-specific data, such as finance and accounting data.

As described in more detail below, based on the embedding of the user query generated by the embedding module 105, the schema selection engine 106 is configured to map an answer-generation schema (“answer plan”) to the user query. This mapped answer-generation schema is then passed to the answer generation engine 107 which performs steps specified in the selected answer-generation schema to generate an answer to the user query.

The answer generation engine 107 is connected to a plurality of data sources 109, which in this instance include an API 109a for retrieving data from an external data system, a database 109b and a Retrieval Augmented Generation (RAG) system 109c for querying a corpus of documents of facts to retrieve relevant information. As is known, such systems use a technique that combines document retrieval and natural text generation to produce answers from large-scale document collections. In this context, the RAG system 109c is a data source that can be queried by the answer generation engine 107 to retrieve relevant facts from a corpus of documents, such as a corpus of financial documents.

This combination of data sources is merely illustrative, and it will be understood that any appropriate number and combination of data sources can be used depending on the specific domain for which the answer-generating agent system 103 is optimised to perform.

As explained in more detail below, the answer generation engine 107 uses data from the plurality of data sources 109 to generate the answer output.

The answer generation engine 107 is further connected to a cached answer database 110 use of which is described in more detail below.

The schema selection engine 106 comprises data storage 111 on which is stored a plurality of query embeddings 112 arranged into a plurality of embeddings sets and a plurality of answer-generation schemas 113. The schema selection engine 106 also includes a schema selection manager 114 and a schema modification function 115 which is connected to an administrator module 116.

As explained in more detail below, some or all of the answer-generation schemas of the plurality of answer-generation schemas 113 are reconfigurable, i.e. can be modified. Specifically, responsive to the receipt of schema modification data received from the administrator module 116, the schema modification function 115 is configured so that it can make modifications to the plurality of answer-generation schemas 113. The schema modification function 115 may also be configured so that it can add further answer generation schemas to the plurality of answer-generation schemas 113 responsive to the receipt of schema creation data received from the administrator module 116.

Each of the plurality of query embedding sets 112 comprise a plurality of example query embeddings. Each of these query embeddings is an embedding of an example query. The example queries are typically each an example of a natural language query of the type that might be generated by a user seeking to answer a question associated with a particular domain, for example finance and accounting.

The example queries used to generate the query embeddings can be obtained in any suitable way. For example, some or all of the example queries can be based on a corpus of real-world queries collected from users who have previously interacted with the system. Alternatively, some or all of the example queries can be manually generated by experts or domain specialists who can anticipate the types of questions that users might ask. Another option is to use synthetic queries that are generated by artificial intelligence (AI) models, such as natural language generation (NLG) models, which can produce realistic and diverse queries. In some cases, a combination of these methods can be used to obtain a sufficient number and variety of example queries. A further example is to provide template questions with variable parts which can be expanded into a plurality of example queries. The example queries are typically domain-specific, meaning that they relate to a particular domain of knowledge or interest, such as finance and accounting, which the system is designed to handle. By using domain-specific queries, the system can learn more accurate and relevant query embeddings that can match the user queries to the appropriate answer-generation schemas.

Using any suitable embedding technique, the user query embeddings can be generated in any suitable way. For example, a suitable embedding model, such as BERT or FastText, can be applied to the user query to produce a high-dimensional vector that represents the semantic and syntactic features of the query. The embedding model can be trained on a large corpus of natural language texts, such as encyclopaedia articles, news articles, books, or web pages, to learn general linguistic patterns. Alternatively, or additionally, the embedding model can be fine-tuned on a specific domain of interest, such as finance and accounting, to learn more specialised and relevant features for the user queries.

Each answer-generation schema of the plurality of answer-generation schemas 113, comprises a schema (or “answer plan”) that define a sequence of the steps that can be implemented by the answer generation engine 107 to generate an answer output.

For simple queries, the sequence of steps may comprise answer data retrieval instructions for retrieving an answer output via a direct look-up, for example by retrieving an answer from a database or via an API.

For more complex queries, the answer-generation schema comprises prompt generation data specifying a sequence of steps to generate a prompt to be input to an AI model, to instruct the AI model to generate an intermediate or final answer to a user query.

Such answer-generation schema typically includes a prompt template specifying the structure of a prompt, prompt variable data specifying a number of prompt variables with which to populate (insert into) the prompt template, and if necessary, variable-obtaining instructions specifying how the prompt variables can be obtained (for example retrieved or derived).

Returning to the data stored in the data storage 111 of the schema selection engine 106, as described above, the example query embeddings are arranged into a plurality of query embedding sets. As is depicted in FIG. 1, each one of these query embedding sets is indexed to one of the answer-generating schemas. This indexing is based on the organisation of the query embedding sets such that all example query embeddings that relate to the same underlying query-and that can therefore be answered by the same answer-generation schema-are all grouped in the same query embedding set. This query embedding set is then indexed to that answer-generation schema.

The indexing of the query embedding sets to the answer-generation schemas can be implemented in any suitable way. For example, by storing data defining the indexing in the data storage 111, such as a table or a dictionary that associates each query embedding set with a corresponding answer-generation schema.

This organisation of the query embedding sets, where the example query embeddings relating to user queries that can be answered by the same answer-generation schema are all organised in the same query embedding set, can be achieved in any suitable way. For example, this can be done automatically based on some form of semantic matching, such as using a similarity measure between the example query embeddings and clustering them according to a predefined threshold. Alternatively, this can be done manually, for example by an expert who can assign the example query embeddings to different query embedding sets based on their knowledge of the underlying queries and the answer-generation schemas. Another possibility is to use a hybrid approach, where the example query embeddings are initially grouped automatically and then refined or verified by human intervention. Additionally, other methods of organising the query embedding sets can be used, such as using topic modelling, keyword extraction, or natural language understanding techniques.

As described in more detail below, in certain embodiments, to map a user query to an answer-generation schema, the embedding of the user query generated by the embedding module 105 is compared to all the example query embeddings, and the example query embedding which it most closely matches is identified.

The schema selection manager 114 is configured to then identify which query embedding set this matched example query embedding belongs and then identify the answer-generation schema which is indexed to that query embedding set. This answer-generation schema is then used by the answer generation engine 107 to generate an answer to a user query.

Advantageously, this arrangement means that the answer-generating agent system 103 is more capable of handling user queries that can be expressed in many distinct ways but relate to the same underlying query, and in particular, is more capable of generating consistent, and deterministic-like answer outputs.

For example, the queries:
“What is the net profit margin of ACME Incorporated?”
and
“how much does acme earn for every dollar of sales?”
   relate to the same underlying query of calculating the ratio of net income to revenue for a company “ACME Incorporated” and which requires data from an income statement relating to that company to be retrieved. However, as these queries are expressed differently, embeddings of these queries may be very different which in conventional approaches may lead to different answer-plans being executed.

However, in accordance with the operation of the schema selection engine 106, this issue is mitigated. Providing a suitably diverse set of example user queries are used for the embeddings provided in each query embedding set (capturing a reflective range of ways in which a query can be expressed), irrespective of the variance in the way user queries are expressed, user queries which relate to the same underlying query will be consistently mapped to the same answer-generation schema, ensuring that answer outputs for related queries are generated by the answer generation engine 107 using the same sequence of steps.

As mentioned above, the schema selection engine 106 further comprises a schema modification function 115 which is configured to receive schema modification data from the administrator module 116 and then modify/reconfigure the answer-generation schemas in accordance with the schema modification data.

Such schema modification data is typically generated due to a need to improve the performance of the system, for example, responsive to feedback or ratings from the users that indicate that certain types of user queries are not being answered well by the existing schemas, or observation that the system 103 is performing poorly for types of queries that have not been previously encountered.

The administrator module 116 can be implemented in any suitable way, for example as software on a computing device configured to provide an interface to oversee the operation of the adaptive answer-generating agent system 103 and via which its operation can be managed. The administrator module 116 may communicate with the schema selection engine 106 and the answer generation engine 107 through a suitable interface, such as a graphical user interface (GUI), a command-line interface (CLI), or an application programming interface (API). As well as generating schema modification data, the administrator module 116 may allow an administrator to perform various management functions, such as monitoring the performance of the system 103, adjusting the parameters of the schema selection engine 106 or the answer generation engine 107, providing feedback or ratings for the generated answers or prompts, adding or deleting data sources or answer-generation schemas, or updating the training data or the embeddings used by the system 103.

The schema modification data may specify modifications, which are implemented by the schema modification function 115, including any one of: adding new steps, removing existing steps or changing the order of some or all of the existing steps.

In examples in which an answer-generation schema comprises a sequence of steps specifying how the answer generation engine 107 can generate a prompt for answering a received user query, the schema modification data may specify how to modify the sequence of steps by modifying one or more of the prompt template, prompt-variable obtaining instructions and prompt variables.

In certain examples, the schema modification function 115 is configured to receive schema creation data from the administrator module 116 which defines a new answer-generation schema and responsive to which the schema modification function 115 is configured to create and store a new answer-generation schema in the plurality of answer-generation schemas 113. The schema creation data may also include query embedding set update data in accordance with which the schema modification function 115 is configured to update the indexing of the plurality of query embedding sets with the plurality of answer-generation schemas 113 (including adding indexing to new answer-generation schema), and/or the plurality of query embedding sets themselves, for example by modification of the example query embeddings organised in the existing plurality of query embedding sets, addition of a new example query embeddings to an existing query embedding set, or the creation of a new query embedding set.

In this way, the performance of the system can be enhanced by adding further answer-generation schemas, rather than simply modifying existing ones.

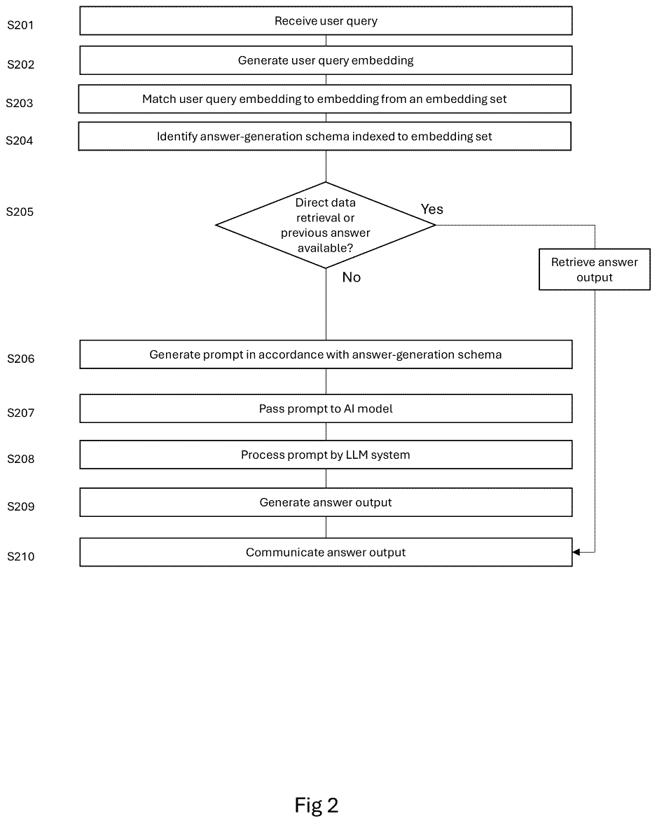

Operation of the computer system 101 is now explained with reference to the flow diagram shown in FIG. 2. FIG. 2 depicts steps of a process for generating an answer to a user query using the adaptive answer-generating agent system 103 described with reference to FIG. 1.

At a first step s201, a user query is communicated from the user device 102 to the interface 104.

At a second step, S202, this user query is communicated to the embedding module 105 which generates an embedding of the user query. At a third step S203, this user query embedding is communicated to the schema selection engine 106.

The schema selection manager 114 is configured to then perform a matching operation between the user query embedding and the example query embeddings from the plurality of query embedding sets 112 to identify the example query embedding that most closely matches the user query embedding. This matching operation can be based on any suitable technique, for example calculating the cosine similarity between the user query embedding and each example query embedding, and selecting the example query embedding that has the highest cosine similarity as the closest match. Alternatively, the matching operation can be based on finding the nearest neighbour of the user query embedding in the embedding space using a distance metric, such as Euclidean distance or Manhattan distance, and selecting the example query embedding that has the smallest distance as the closest match.

At a fourth step S204, the schema selection manager 114 is configured to determine which query embedding set the matched example query embedding is allocated to, and then, identify which answer-generation schema is indexed to this query embedding set.

The schema selection manager 114 then selects this answer-generation schema and forwards it to the answer generation engine 107.

At a fifth stage S205 the answer generation engine 107 is configured to query the cached answer database 110 to determine if a query matching the user query has previously been answered, and if so, the answer generation engine 107 retrieves the relevant answer data from the cached answer database 110 and the process proceeds to the tenth step S210 where a corresponding answer output is generated by the answer generation engine 107 and communicated to the user device 102 via the interface 104.

Such a query of the cached answer database 110 by the user query can be achieved in any suitable way. For example, the answer generation engine 107 can extract the keywords and phrases from the user query that are relevant to the domain and intent of the answer-generation schema, and construct a query string based on them. The answer generation engine 107 can optionally apply some filtering or ranking criteria to narrow down the search results, and send the query string to the cached answer database 110. The answer generation engine 107 can then receive a list of matching records that contain previously generated answer outputs for similar queries, and compare the user query with them. The answer generation engine 107 can select the most relevant record based on some similarity measure or confidence score, and retrieve the answer output from it. The answer generation engine 107 can then return the answer output to the user device 102 via the interface 104.

If no cached answer is identified, if the answer-generation schema provides answer data retrieval instructions for retrieving an answer output via direct data retrieval, for example from the API 109a or database 109b, the answer generation engine 107 retrieves the relevant answer data and the process proceeds to the twelfth step S212 where a corresponding answer output is generated by the answer generation engine 107 and communicated to the user device 102 via the interface 104.

On the other hand. if no cached answer is identified, and no answer is available via direct retrieval, at a sixth step S206, the answer generation engine 107 generates a prompt by performing the sequence of steps defined in the answer-generating schema. As noted above, this typically comprises obtaining one or more prompt variables specified in the prompt variable data, and inserting them into the prompt template to generate the prompt in accordance with variable-obtaining instructions specifying how the prompt variables can be obtained.

In certain examples, the prompt variables specify one or more user-generated data variables, and the variable-obtaining instructions comprise derivation instructions specifying how to derive the one or more of user-generated data variables from the user query itself (e.g. rather than from the plurality of data sources 109). In such examples, the answer generation engine 107 is configured to retrieve the original user query from the interface 104 and then obtain the user-generated data variables by deriving them from the user query in accordance with the derivation instructions.

As the skilled person will understand, the derivation instructions can define how the answer generation engine 107 derives the one or more user-generated data variables from the user query in any suitable way. For example, if the derivation instructions comprise instructions to extract an organisation name from the user query, the answer generation engine 107 can parse the user query using natural language processing techniques to identify noun phrases that refer to entities or organisations, and select the most relevant one based on the domain and intent of the answer-generation schema. Alternatively, the answer generation engine 107 can use named entity recognition techniques to tag and extract the organisation names from the user query, and rank them based on their frequency or prominence in the query. Similar techniques can be used to derive other types of data from the user query, for example amounts, values, dates, times, and so on.

In certain examples, the prompt variables specify one or more retrievable data variables, and the variable-obtaining instructions comprise data retrieval instructions specifying how to retrieve the one or more retrievable data variables from one or more data sources, for example one or more of the API 109a, database 109b and RAG system 109c. For example, the data retrieval instructions may comprise instructions for accessing data from specific databases (e.g. specific SQL queries), via specific APIs (e.g. specific API calls) and specific queries to RAG systems (e.g. specific RAG queries).

In such examples, the answer generation engine 107 is configured to retrieve the one or more retrievable data variables by retrieving them from the one or more data sources in accordance with the data retrieval instructions.

Once the prompt has been generated, at a seventh step S207, the answer generation engine 107 passes the prompt to the LLM module 108, which at an eighth step S208 processes the prompt and at a ninth step S209 generates an answer output.

At a tenth step S210, the answer generation engine 107 communicates the answer output to the interface 104 which in turn communicates the answer data to the user device 102. In certain examples, at this stage, the answer generation engine 107 may also write the answer output to the cached answer database 110 along with user query for retrieval if a similar user query is subsequently received.

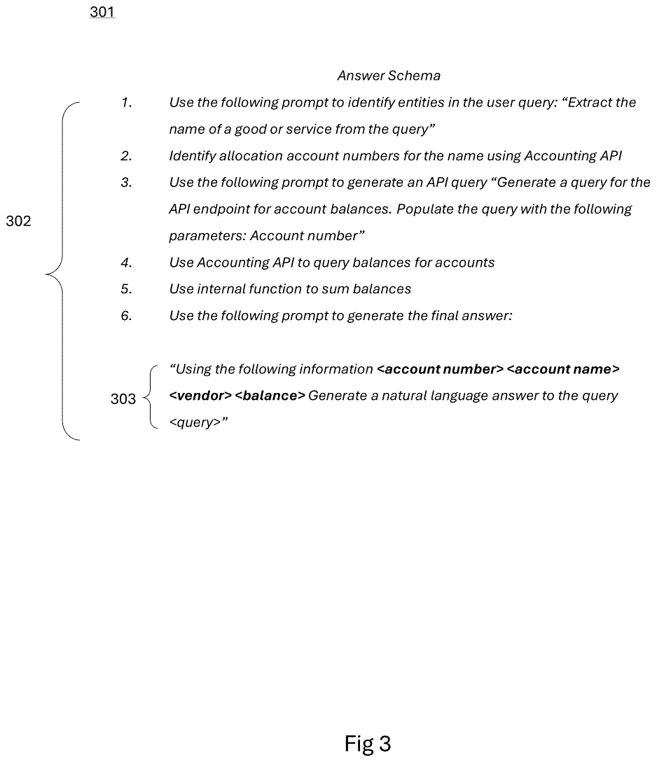

FIG. 3 provides an example of an answer-generation schema 301. In this example, the answer-generation schema provides a sequence of steps for answering user queries which relate to spending with a specific supplier over a specific time frame.

The answer-generation schema shown in FIG. 3 is represented in plain text for illustrative purposes, but as the skilled person will understand, answer generation schemas in accordance with examples of the invention can be in any suitable format that can be processed by the answer generation engine 107. For example, the schema could be written in a scripting language, such as Python, R, or SQL, or in a markup language, such as XML, JSON, or YAML. Alternatively, the schema could be expressed as a graphical model, such as a flowchart, a decision tree, or a UML diagram.

Example user query embeddings organised within a query embedding set that is indexed to this answer-generation schema may be embeddings of user queries such as:
“What have I spent on <good or services> with <entity X> over <specified period>”
“Show me my expenditures on <goods or services> from <entity X> over the past <specified period>”
“what's gone out to <entity x> on <goods or services> during <specified period>”

As can be seen from FIG. 3, the answer-generating schema 301 comprises a sequence of steps 302 to generate a prompt which include: prompt variable data specifying a number of prompt variables and variable-obtaining instruction data specifying how to obtain the prompt variables from the user query and various data sources, and a prompt template 303.

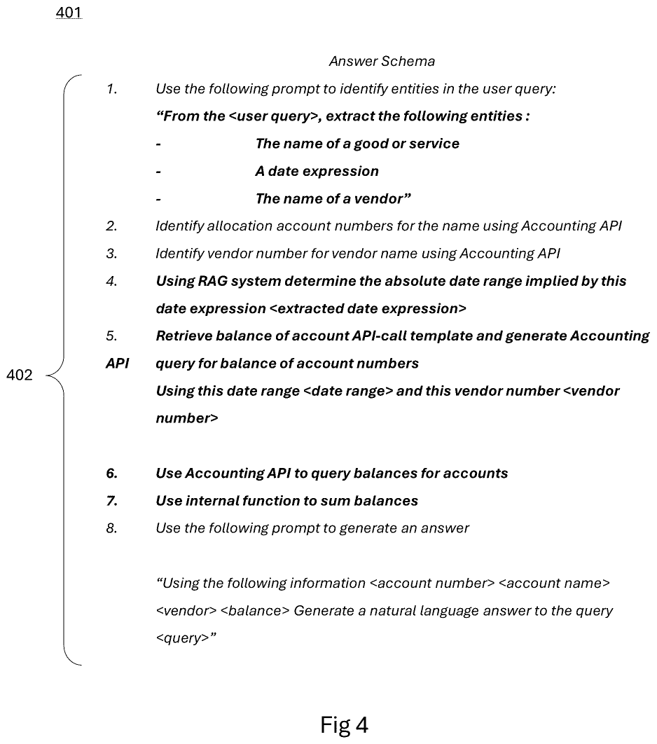

In this example, it may be determined, that better answer generation results are obtained if the answer-generating schema 301 is replaced by the modified prompt template 401 depicted in FIG. 4. As can be seen from FIG. 4, in this modified prompt template, certain steps of the sequence of steps 402 are modified (as indicated in bold) to better specify the prompt variable obtaining instructions which may be expected to lead to more accurate outputs from the LLM module 108.

Accordingly, in such an example, based on suitable data received from the administrator module 116, the schema modification function 115 may receive schema modification data which specifies that the prompt template 303 of answer-generating schema 301 should be replaced with an updated prompt template 401 as shown in FIG. 4.

On receipt of such data, the schema modification function 115 would access the answer-generating schema 301 stored in the data storage 111, and modify the answer-generating schema 301 producing a modified answer-generation schema 401 as shown in FIG. 4.

An example of generation an answer output using this modified answer-generation schema 401 is now provided with reference to FIGS. 1 and 2.

In this example, the adaptive answer-generating agent system 103 may be configured to provide answers relating to the finance and accounting domain including answering business analysis queries.

In such an example, the user query embeddings organised into the query embedding sets stored in the data storage 112 would be embeddings of user queries relating to accounting queries such as:
“How much has been spent on product X with supplier Z this quarter?”
“What are the total travel expenses for staff this year?”
“How much revenue has been generated from client Z in the last quarter?”
The answer-generation schemas stored in the data storage 113 would comprise answer plans comprising a sequence of steps to answer such queries. Such steps might include: obtaining relevant data from data sources, such as financial reports, customer surveys, market research, etc. ; obtaining relevant data from the user query, such as the names of companies, products, industries, or other criteria; performing analysis calculations, such as computing ratios, percentages, averages, correlations, regressions, or other statistical measures; and formatting and presenting the results, such as using tables, charts, graphs, or natural language summaries.
At the first step S201 a user query is received from the user device 102, in this illustrative example:
“How much have I spent on office supplies at Officeworks this quarter?”

At the second step S202, the embedding module 105 generates an embedding of this user query, and at the third step S203, the embedding module 105 passes the embedding to the adaptive answer-generating agent system 103 and the schema selection manager 114 determines: a) which example query embedding most closely matches the embedding of the query, and then b) which query embedding set this example query embedding belongs to.

In this instance, the example query embedding that the user query embedding most closely matches, may be an embedding of an example user query such as:
“What have i spent on <good or services> with <vendor x> over <specified period>”

This example query may belong to a query embedding set comprising embeddings of example queries which are seeking a brief textual summary of the amount spent with a given organisation on a given class of goods and service over a given time period.

At the fourth step, S204 the answer generation engine 107 identifies the answer-generating schema indexed to this query embedding set, which in this instance may be the modified answer-generation schema 401 shown in FIG. 4.

As can be seen from FIG. 4, the modified answer-generation schema 401 requires the generation of a prompt for processing by the LLM module 108, so the process proceeds to the sixth step S206, where the answer generation engine 107 generates a prompt in accordance with the modified answer-generation schema 401.

In this instance, in accordance with step 1) of the modified answer-generation schema 401, the answer generation engine 107 generates a prompt to pass to the LLM module 108 to identify the goods and services, vendor identity and specified period associated with the user query.

In this example, this prompt may take the following form:
“From the query “How much have I spent on office supplies at Officeworks this quarter? Extract the following entities:
   The name of a good or service
   A date expression defining a specified period
   The name of a vendor””

In this instance, the LLM module 108 may return a response identifying:
“Office supplies” as the goods or service
“current quarter” as a date expression
“Officeworks” as the name of a vendor

In accordance with step 2) of the modified answer-generation schema 401, the answer generation engine 107 then retrieves allocation account numbers for the vendor: “OfficeWorks” by making an appropriate call to an API, for example an Accounting API provided by API 109a which may provide access to accounting data associated with a particular organisation.

In accordance with step 3) of the modified answer-generation schema 401, the answer generation engine 107 then retrieves a vendor number (for example “12345”) associated with the vendor name: “OfficeWorks” by making an appropriate call to the Accounting API provided by the API 109a.

In accordance with step 4) of the modified answer-generation schema 401, using the RAG system 109c which in this instance may implement a RAG system enabling data records relating to specified organisations to be queried and relevant data returned, the answer generation engine 107 determines the absolute date range implied by the date expression: “this quarter”.

In this instance, the rag system 109 c may return a date range of “July to September 2024”.

In accordance with step 5) of the modified answer-generation schema 401, the answer generation engine 107 is configured to retrieve an appropriate API call template and generate an accounting API query to return balance of account numbers using the date range of “July to September 2024” retrieved from the RAG system 109c and the vendor number “12345” retrieved from the Accounting API provided by the API 109a.

In accordance with step 6) of the modified answer-generation schema 401, the answer generation engine 107 passes this API query to the Accounting API provided by the API 109a as an API request to identify the relevant balance of account numbers.

In this example, the API 109a may return a set of balances for the account numbers associated with purchases of office supplies from OfficeWorks during the specified period, for example:
“Account number 001234; account name “Office Supplies”; balance $3,500”
and
“Account number 001235, account name “Miscellaneous Office Expenses”, balance $1,000.”

In accordance with step 7) of the modified answer-generation schema 401, the answer generation engine 107 uses an internal summing function to sum these balances to generate a total balance of the amount spent at the vendor “OfficeWorks” over the date range of “July to September 2024”, which in this example would result in a total of $4,500.

In accordance with step 8) of the modified answer-generation schema 401, the answer generation engine 107 generates the following prompt:
“Using the following information:
   Account number 001234, account name ‘Office Supplies’, balance $3,500
   Account number 001235, account name ‘Miscellaneous Office Expenses’, balance $1,000
   Vendor: Officeworks
Generate a natural language answer to the query: ‘How much have I spent on office supplies at Officeworks this quarter?’”

Returning to the process depicted in FIG. 2, at the seventh step S207, this prompt is then communicated by the answer generation engine 107 to the LLM module 108, which at an eighth step S208, passes it through a Large Language Model to generate an answer output at the ninth step S209. FIG. 7 shows an example output answer 701 based on the completed prompt 601 shown in FIG. 6.

In this example, the LLM module 108 may generate the following output:
“Between July and September 2024, you spent a total of $ 4,500 on office supplies at OfficeWorks. This includes $3,500 from your ‘Office Supplies’ account and $1,000 from your ‘Miscellaneous Office Expenses’ account.”

At the tenth step S210, the LLM module 108 communicates the output answer 701 to the user device 102 via the interface 104.

In keeping with the example described above, a typical sequence of steps provided by an answer-generation schema may involve a combination of steps that specify how to retrieve or derive data for determining one or more prompt variables from various data sources. These sources might include databases, APIs, RAG systems, data processing functions (such as the internal summing function of the answer generation engine 107 mentioned earlier), or a generative AI system like the LLM module 108 itself.

However, in certain examples, the sequence of steps of an answer-generation schema may comprise one or more steps that specify instructions for the dynamic generation of a sequence of one or more sub-steps, which are also then executed by the answer generation engine 107 to generate the output. In some such examples, the instructions for the dynamic generation of the sub-steps specify the use of an AI model, such as the LLM module 108, to generate the sub-steps based on parameters obtained from the user query. For example, with reference to the example shown in FIG. 4, step 5 of the sequence of steps involves retrieving a balance of account call template and generating an Accounting API query for the balance of account numbers by populating the template with the specified date range and vendor number. However, in an alternative embodiment, step 5 may instead specify an instruction for the dynamic generation of sub-steps to construct and execute the necessary Accounting API query. For example, step 5 may be as follows:
“5. Use the LLM module 108 to generate one or more sub-steps necessary to construct and execute an Accounting API query to retrieve the balances of the identified account numbers, utilising the date range and vendor number obtained previously.”

In this case, the answer generation engine 107 uses the LLM module 108 to generate a sequence of sub-steps tailored to the specific parameters obtained from the user query, such as the account numbers, date range, and vendor number. These dynamically generated sub-steps may include, for example:
5a. Prepare the query parameters by formatting the account numbers, date range, and vendor number according to the requirements of the Accounting API.
5b. Construct the API endpoint URL by appending the formatted query parameters to the base URL of the Accounting API.
5c. Set up the necessary authentication and headers for the API request, including any required API keys or tokens.
5d. Execute the API request by sending it to the constructed endpoint URL with the appropriate headers and parameters.
5e. Process the API response to extract the account balances associated with the specified account numbers.
5f. Implement error handling procedures to manage any exceptions or failures that may occur during the API call, such as network errors or invalid responses.

By dynamically generating these sub-steps, the system can adapt to varying requirements and complexities of different user queries, thereby enhancing the flexibility and robustness of the answer generation process.

Returning to FIG. 1, as the skilled person will understand, the computer system 101 and in particular the adaptive answer-generating agent system 103 and components thereof can be implemented in any suitable way. For example, the adaptive answer-generating agent system 103 may be implemented as a standalone module that can be invoked by other applications or services via an application programming interface (API) or a web service. Alternatively, the system 103 may be integrated into a larger software system that provides various functionalities related to natural language processing, such as a chatbot, a question answering system, a document analysis system, or a search engine.

Elements of the adaptive answer-generating agent system 103 for storing data, including for example the cached answer database 110 and the data storage 111, can be implemented in any suitable way. For instance, they may be local or remote devices that store data in various formats, such as relational or document databases. They may also be distributed across multiple devices or locations, such as in a cloud or a blockchain. They may support different operations and access modes, such as querying, updating, encrypting, or read-write. They may be accessed by the system 103 via different protocols, such as SQL, NoSQL, API, or Web Service.

Similarly to the data storage elements, the functional elements of the adaptive answer-generating agent system 103, such as the answer generation engine 107, the schema selection manager 114, and the schema modification function 115, can be implemented in any suitable way. For instance, they may be software modules, functions, classes, or objects that are written in any programming language, such as Java, Python or C++. They may also be hardware components, such as processors, memory units, or circuits that execute instructions or logic operations. They may be configured to run on different platforms, such as Windows, Linux, MacOS, Android, or iOS. They may have different dependencies, libraries, frameworks, or APIs that support their functionality. They may be deployed in different environments, such as local or remote servers, cloud computing services, edge devices, or mobile devices.

The LLM module 108 may be implemented in different ways, depending on the availability and location of the LLM model. For example, the LLM module 108 may comprise a software component that runs the LLM model locally on the same device or server as the rest of the system 103. In this case, the LLM module 108 may have direct access to the LLM model parameters and may perform the inference and training operations internally. Alternatively, the LLM module 108 may comprise a suitable interface, such as an application programming interface (API) or a web service, which allows the system 103 to communicate with a remotely implemented LLM model. In this case, the LLM module 108 may send queries and data to the remote LLM model and receive the results back via the interface. The remote LLM model may be hosted on a different device, server, cloud service, or edge device, and may be shared by multiple systems or applications.

As the skilled person will understand, in certain embodiments, the LLM module 108 may be replaced or supplemented by an AI module that implements alternative AI models or artificial intelligence technologies. For instance, the AI module may deploy a decision tree model, a support vector machine, or various forms of neural networks such as convolutional or recurrent neural networks depending on the specific requirements and constraints of the system 103. In another embodiment, the AI module could utilise Bayesian networks or engage reinforcement learning models to optimise decision-making processes.

The plurality of data sources 109, and in particular the database 109b and RAG system 109c, may be implemented in different ways, depending on the availability and location of the data and the RAG model. For example, the database 109b and RAG system 109c may be part of the same device or server as the rest of the adaptive answer-generating agent system 103, and may store and process data locally. In this case, the data sources 109 may have direct access to the data and the RAG model parameters, and may perform the data retrieval and RAG inference operations internally. Alternatively, the database 109b and RAG system 109c may be implemented remotely, and may be accessed by the adaptive answer-generating agent system 103 via suitable means, such as application programming interfaces (APIs) or web services. In this case, the data sources 109 may send queries and data to the remote database and RAG system, and receive the results back via the APIs or web services. The remote database and RAG system may be hosted on a different device, server, cloud service, or edge device, and may be shared by multiple systems or applications.

The user device 102 can be any suitable type of user device that is capable of receiving and displaying information, such as a personal computer, laptop, tablet, smartphone, smartwatch, smart speaker, or virtual reality headset. The user device 102 can be connected to the adaptive answer-generating agent system 103 by any suitable data communication means, such as wired or wireless networks, cellular networks, Bluetooth, Wi-Fi, or the Internet. The user device 102 can communicate with the adaptive answer-generating agent system 103 using any suitable protocol, such as HTTP, HTTPS, FTP, MQTT, or WebSocket. The user device 102 can also run any suitable software application, such as a web browser, a mobile app, a voice assistant, or a chatbot, that allows the user to interact with the adaptive answer-generating agent system 103 and receive answers to their queries. The user device 102 can also have various input and output devices, such as a keyboard, a mouse, a microphone, a speaker, a touch screen, or a camera, which enable the user to provide inputs and receive outputs in different modalities, such as text, speech, image, or video.

Similarly, the administrator module 116 can be implemented on any suitable type of computing device that can perform the functions described above, such as a personal computer, laptop, tablet, smartphone, or server. For example, the administrator module 116 may be implemented on a separate device or server that is accessible to the administrators of the system 103, or on the same device or server that hosts the system 103. The administrator module 116 may also have various input and output devices, such as a keyboard, a mouse, a microphone, a speaker, a touch screen, or a camera, which enable the administrators to provide inputs and receive outputs in different modalities, such as text, speech, image, or video.

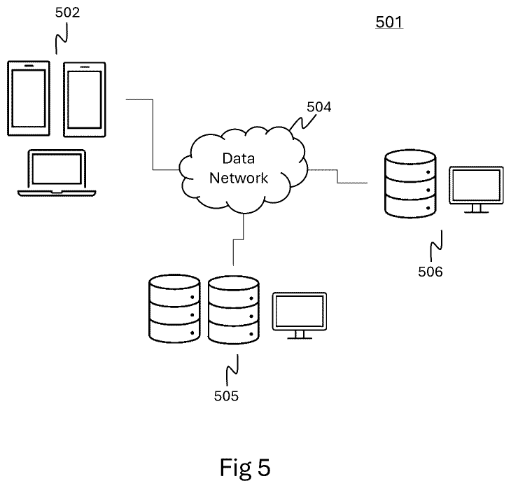

FIG. 5 provides a simplified schematic diagram of a system 501 for implementing an example of the adaptive answer-generating agent system 103 described above. The system 501 comprises a plurality of user devices 502, which are configured to communicate with a computing system 503 via a data network 504, such as the Internet. The computing system 503 can be provided by any suitable computing system such as a server system, a cloud computing system, or an edge computing system.

The system 501 comprises a further computing system 505 for implementing a knowledge database and RAG system which is configured to communicate data to and from the adaptive answer-generating agent system hosted on the computing system 503 via the data network 504.

It will be appreciated by those skilled in the art that, although the example embodiments have been described primarily in terms of user queries relating to the field of finance and accounting, the invention is not limited thereto. The systems and methods described herein may be implemented in other domains where AI models are utilised to generate answers to user queries, including but not limited to medicine and healthcare, legal services, education, engineering, retail and e-commerce, travel and hospitality, and other similar fields.

All of the features disclosed in this specification (including any accompanying claims, abstract and drawings), and/or all of the steps of any method or process so disclosed, may be combined in any combination, except combinations where at least some of such features and/or steps are mutually exclusive. Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features. The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognise that such recitation should be interpreted to mean at least the recited number (e.g., the bare recitation of “two recitations,” without other modifiers, means at least two recitations, or two or more recitations).

It will be appreciated that various embodiments of the present disclosure have been described herein for purposes of illustration, and that various modifications may be made without departing from the scope of the present disclosure. Accordingly, the various embodiments disclosed herein are not intended to be limiting, with the true scope being indicated by the following claims.

1. A computer implemented adaptive answer-generating agent, said adaptive answer-generating agent implemented on a computer system and communicatively connected to a user device, said adaptive answer-generating agent configured to:
receive a user query from the user device;
map the user query to one of a plurality of reconfigurable answer-generation schemas stored in first data storage, each of the answer-generation schema specifying a sequence of steps to generate an answer output to the query, said adaptive answer-generating agent comprising an answer generation engine configured to:
receive the answer-generation schema mapped to the user query;
implement the sequence of steps to generate an answer output, and
communicate the answer output to the user device, wherein
the adaptive answer-generating agent further comprises a schema modification function configured to:
receive schema modification data from a further computing device relating to one or more of the answer-generation schemas, and
modify the sequence of steps of the one or more of the answer-generation schemas in accordance with the schema modification data.

2. An adaptive answer-generating agent according to claim 1, wherein at least some of the reconfigurable answer-generation schemas specify a sequence of steps to generate a prompt to pass to an AI model to answer a query, and when such a reconfigurable answer-generation schema is mapped to a user query, the answer generation engine is configured to:
generate a prompt in accordance with the sequence of steps of the answer-generation schema mapped to the user query, and
pass the prompt to an AI model to generate the answer output.

3. An adaptive answer-generating agent according to claim 2, wherein on receipt of schema modification data relating to a reconfigurable answer-generation schema specifying a sequence of steps to generate a prompt, the schema modification function is configured to:
modify the sequence of steps to generate the prompt for the AI model.

4. An adaptive answer-generating agent according to claim 3, wherein the reconfigurable answer-generation schemas that specify a sequence of steps to generate a prompt to pass to an AI model to answer a query, comprise steps to:
obtain one or more prompt variables in accordance with prompt-variable obtaining instructions,
insert the one or more obtained prompt variables into a prompt template to generate the prompt, and
the schema modification data relating to a reconfigurable answer-generation schema specifying a sequence of steps to generate a prompt, comprises modification data to modify the sequence of steps by modifying one or more of the prompt template, prompt-variable obtaining instructions and prompt variables.

5. An adaptive answer-generating agent according to claim 4, wherein the prompt-variable obtaining instructions comprise data retrieval instructions specifying how to retrieve data for determining one or more prompt variables from one or more data sources.

6. An adaptive answer-generating agent according to claim 5, wherein the one or more data sources comprises one or more of: one or more specified databases; one or more specified APIs; a retrieval augmented generation (RAG) system, and one or more data processing functions.

7. An adaptive answer-generating agent according to claim 4, wherein one or more of the reconfigurable answer-generation schemas specify a sequence of steps comprising at least one step that includes instructions for a dynamic generation of a sequence of one or more sub-steps, which are executed by the answer generation engine to generate the prompt.

8. An adaptive answer-generating agent according to claim 7, wherein the instructions for the dynamic generation of the sub-steps specify use of an AI model to generate the sub-steps based on parameters obtained from the user query.

9. An adaptive answer-generating agent according to claim 1, comprising an embedding module and a schema selection manager, wherein the data storage has stored thereon a plurality of example query embeddings, each of which are embeddings of an example user query, said plurality example query embeddings organised into a plurality of query embedding sets, each query embedding set indexed to one of the reconfigurable answer-generation schemas, wherein
said embedding module is configured to generate an embedding of the received user query and said schema selection manager configured to:
match the user query embedding to one of the plurality of example query embeddings;
identify a query embedding set to which the example query embedding is allocated;
identify the answer-generation schema to which the identified query embedding set is indexed, and
map the user query to the identified answer-generation schema.

10. An adaptive answer-generating agent according to claim 2, wherein prior to generating the prompt in accordance with the answer-generation schema, the answer generation engine is configured to:
query further data storage for a cached answer stored in a memory for the user query; and if there is a cached answer
outputting the cached answer as the answer output to the user query without generating the prompt.

11. An adaptive answer-generating agent according to claim 1, wherein at least some of the reconfigurable answer-generation schemas specify answer data retrieval instructions for retrieving an answer output via a direct look-up from a data source, and when such a reconfigurable answer-generation schema is mapped to a user query, the answer generation engine is configured to:
retrieve the answer output from the data source in accordance with the data retrieval instructions.

12. An adaptive answer-generating agent according to claim 1, wherein the schema modification function is further configured to:
receive schema creation data from the further computing device specifying a new answer-generation schema, and
add a new reconfigurable answer-generation schemas to the plurality of reconfigurable answer-generation schemas in accordance with the schema creation data.

13. A computer-implemented method for updating an adaptive answer-generating agent implemented on a computer system, said adaptive answer-generating agent configured to: receive a user query from the user device; map the user query to one of a plurality of reconfigurable answer-generation schemas stored in first data storage, each of the answer-generation schema specify a sequence of steps to generate an answer output to the query, said adaptive answer-generating agent comprising an answer generation engine configured to: receive the answer-generation schema mapped to the user query; implement the sequence of steps to generate an answer output, and communicate the answer output to the user device, said method comprising:
receiving, at the adaptive answer-generating agent, schema modification data from a further computing device relating to one or more of the answer-generation schemas, and
modifying the sequence of steps of the one or more of the answer-generation schemas in accordance with the schema modification data.

14. A computer implemented method according to claim 13, wherein at least some of the reconfigurable answer-generation schemas specify a sequence of steps to generate a prompt to pass to an AI model to answer a query, and when such a reconfigurable answer-generation schema is mapped to a user query, and the answer generation engine is configured to:
generate a prompt in accordance with the sequence of steps of the answer-generation schema mapped to the user query, and
pass the prompt to an AI model to generate the answer output.

15. A computer implemented method according to claim 14, wherein on receipt of schema modification data relating to a reconfigurable answer-generation schema specifying a sequence of steps to generate a prompt, the method further comprises:
modifying the sequence of steps to generate the prompt for the AI model.

16. A computer implemented method according to claim 15, wherein the reconfigurable answer-generation schemas that specify a sequence of steps to generate a prompt to pass to an AI model to answer a query, comprise steps to:
obtain one or more prompt variables in accordance with prompt-variable obtaining instructions,
insert the one or more obtained prompt variables into a prompt template to generate the prompt, and
the schema modification data relating to a reconfigurable answer-generation schema specifying a sequence of steps to generate a prompt, comprises modification data to modify the sequence of steps by modifying one or more of the prompt template, prompt-variable obtaining instructions and prompt variables.

17. A computer implemented method according to claim 16, wherein the prompt-variable obtaining instructions comprise data retrieval instructions specifying how to retrieve data for determining one or more prompt variables from one or more data sources.

18. A computer implemented method according to claim 17, wherein the one or more data sources comprises one or more of: one or more specified databases; one or more specified APIs; a retrieval augmented generation (RAG) system, and one or more data processing functions.

19. A computer implemented method according to claim 16, wherein one or more of the reconfigurable answer-generation schemas specify a sequence of steps comprising at least one step that includes instructions for a dynamic generation of a sequence of one or more sub-steps, which are executed by the answer generation engine to generate the prompt.

20. A computer implemented method according to claim 19, wherein the instructions for the dynamic generation of the sub-steps specify use of an AI model to generate the sub-steps based on parameters obtained from the user query.

21. A computer implemented method according to claim 13, wherein the adaptive answer generating agent comprises an embedding module and a schema selection manager, wherein the data storage has stored thereon a plurality of example query embeddings, each of which are embeddings of an example user query, said plurality example query embeddings organised into a plurality of query embedding sets, each query embedding set indexed to one of the reconfigurable answer-generation schemas, wherein
said embedding module is configured to generate an embedding of the received user query and said schema selection manager configured to:
match the user query embedding to one of the plurality of example query embeddings;
identify a query embedding set to which the example query embedding is allocated;
identify the answer-generation schema to which the identified query embedding set is indexed, and
map the user query to the identified answer-generation schema.

22. A computer implemented method according to claim 14, wherein prior to generating the prompt in accordance with the answer-generation schema, the answer generation engine is configured to:
query further data storage for a cached answer stored in a memory for the user query; and if there is a cached answer
outputting the cached answer as the answer output to the user query without generating the prompt.

23. A computer implemented method according to claim 13, wherein at least some of the reconfigurable answer-generation schemas specify answer data retrieval instructions for retrieving an answer output via a direct look-up from a data source, and when such a reconfigurable answer-generation schema is mapped to a user query, the answer generation engine is configured to:
retrieve the answer output from the data source in accordance with the data retrieval instructions.

24. A computer implemented according to claim 13, further comprising:
receiving schema creation data from a further computing device specifying a new answer-generation schema, and
adding a new reconfigurable answer-generation schemas to the plurality of reconfigurable answer-generation schemas in accordance with the schema creation data.
